(19) United States
(12) Patent Application Publication
(10) Pub. No.: US 2025/0323297 A1
(43) Pub. Date: Oct. 16, 2025

(54) METHOD FOR OPERATING A CELL STACK COMPRISING A NUMBER OF ELECTROCHEMICAL CELLS ARRANGED ONE ABOVE THE OTHER AND SEALED OFF FROM ONE ANOTHER

(71) Applicant: Robert Bosch GmbH, Stuttgart (DE)

(72) Inventor: Lucas Prinsen, Rijen (NL)

(21) Appl. No.: 18/868,043

(22) PCT Filed: May 24, 2023
(86) PCT No.: PCT/EP2023/063891

§ 371 Date: Dec. 18, 2024

(30) Foreign Application Priority Data
May 25, 2022 (DE) 10 2022 205 237.4

(51) Int. Cl. H01M 8/04746; H01M 8/04223

(52) U.S. Cl. CPC H01M 8/04761; H01M 8/04231; H01M 8/04753; H01M 2250/20

(57) ABSTRACT

The invention relates to a method for operating a cell stack (12) comprising a number of electrochemical cells (10) which are arranged one above the other, are sealed off from one another, and through which a gaseous medium (38), in particular H₂, flows, which gaseous medium leaves the cell stack (12) via at least one outlet channel (32; 84, 86). According to one variant, one outlet channel (32) for the gaseous medium (38), in particular H₂, comprises open ends (52) at its ends for the outflow of the gaseous medium (38). In a second embodiment, a first outlet channel (84) for the gaseous medium (38), in particular H₂, and a second outlet channel (86) for the gaseous medium (38), in particular H₂, are alternately opened or closed at their ends by means of diagonally acting pairs (96, 98) of valves (88, 90, 92, 94) in such a way that, at the first and at the second outlet channel (84, 86), one end is always a closed end (50), and an opposite end is always an open end (52).

### BACKGROUND

The invention relates to a method for operating a cell stack comprising a number of electrochemical cells which are arranged one above the other, are sealed off from one another, and through which a gaseous medium, in particular H₂, flows, which gaseous medium leaves the cell stack via at least one outlet channel. Furthermore, the invention relates to the use of the method for operating a cell stack with a number of electrochemical cells as an electrolyzer or as a fuel cell for driving a vehicle.

Electrochemical cells are electrochemical energy transducers and are known in the form of fuel cells or electrolyzers.

A fuel cell converts chemical reaction energy into electrical energy. In know fuel cells, hydrogen (H₂) and oxygen (O₂) in particular are converted into water (H₂O), electrical energy and heat.

Proton-exchange membrane (PEM) fuel cells are known, among others. Proton-exchange membrane fuel cells comprise a centrally arranged membrane that is permeable to protons, i.e. hydrogen ions. The oxidizing agent, in particular atmospheric oxygen, is thereby spatially separated from the fuel, in particular hydrogen.

Fuel cells comprise an anode and a cathode. The fuel is continuously supplied to the fuel cell at the anode and catalytically oxidized with loss of electrons to form protons that reach the cathode. The lost electrons are discharged from the fuel cell and flow via an external circuit to the cathode. The oxidizing agent is supplied to the fuel cell at the cathode and reacts to form water by receiving the electrons from the external circuit and protons. The resulting water is drained from the fuel cell. The gross reaction is:

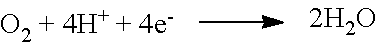

A voltage is in this case applied between the anode and the cathode of the fuel cell. In order to increase the voltage, a plurality of fuel cells can be mechanically arranged one behind the other to form a fuel cell stack, which can also be referred to as a fuel cell system, and can be electrically connected in series.

A stack of electrochemical cells, which can be referred to as an arrangement of electrochemical cells, typically comprises end plates that press the individual cells together and impart stability to the stack.

The electrodes, i.e. the anode and the cathode, and the membrane can be structurally assembled to form a membrane-electrode assembly (MEA).

Stacks of electrochemical cells further comprise bipolar plates, also referred to as gas distributor plates or distributor plates. Bipolar plates serve to distribute the fuel evenly to the anode and to distribute the oxidizing agent evenly to the cathode. In addition to the media guidance with respect to oxygen, hydrogen, water, and optionally a coolant, the bipolar plates ensure a planar electrical contact to the membrane.

A fuel cell stack typically comprises up to several hundred individual fuel cells stacked one on top of the other in layers. The individual fuel cells comprise one MEA and a bipolar plate half on both the anode side and the cathode side. In particular, a fuel cell comprises an anode monopolar plate and a cathode monopolar plate, typically in each case in the form of embossed sheets, which together form the bipolar plate and thus form channels for guiding gas and liquids, between which the cooling medium can flow.

Electrochemical cells typically further comprise gas diffusion layers arranged between a bipolar plate and an MEA.

In contrast to a fuel cell, an electrolyzer is an energy converter, which, while applying electrical voltage, preferably splits water into hydrogen and oxygen. electrolyzers also have MEAs, bipolar plates, and gas diffusion layers, among other things.

Electrochemical cells in a stack are often supplied with the media, in particular hydrogen and oxygen, or these media are discharged via media channels arranged perpendicular to the membrane of the electrochemical cells. The media channels are fluidically connected to the electrochemical cells, in particular to the bipolar plates, by ports, which can also be referred to as fluid terminals. The media channels are typically located on the edge of the stack and are often generated by congruently overlapping recesses forming the ports. From the ports, the media are fed through port passages into what is referred to as the flow-field, the active surface of the bipolar plate or the membrane electrode assembly. The various media must be sealed off from one another and the surroundings, at the ports in particular.

In particular, the port passages for air or hydrogen facing the MEA are designed so that the port passages provide as large an opening as possible for the inflowing and outflowing media and, on the other hand, provide the best possible mechanical support effect for seals arranged on the opposite side of the MEA.

DE 10158772 C1 and DE 10248531 B4 relate to fuel cell stacks with a layering of multiple fuel cells, whereby media are fed or discharged by bipolar plates and bead arrangements are provided for the sealing.

### SUMMARY

According to the invention, a method for operating a cell stack is proposed comprising a number of electrochemical cells which are arranged one above the other, are sealed off from one another, and through which a gaseous medium, in particular H₂, flows, which gaseous medium leaves the cell stack via at least one outlet channel, wherein it is provided that
a) an outlet channel for the gaseous medium, in particular H₂, comprises open ends at its ends for the outflow of the gaseous medium, in particular H₂, or
b) a first outlet channel for the gaseous medium, in particular H₂, and a second outlet channel for the gaseous medium, in particular H₂, are alternately opened or closed at their ends by means of diagonally acting pairs of valves in such a way that, at the first and at the second outlet channel, one end is always a closed end, and an opposite end is always an open end.

The operating method proposed according to the present invention can advantageously achieve that the pressure distribution of the gaseous medium is significantly equalized with respect to all electrochemical cells arranged in the cell stack. By equalizing the pressure of the gaseous medium between the individual electrochemical cells in the cell stack, the yield of generated gaseous medium, in particular H₂, can be advantageously increased so that overall a much more efficient operation of the cell stack from electrochemical cells can be achieved.

In an advantageous further development of the method proposed according to the invention, a controllable valve is assigned to each end of the outlet channels, which closes one end and opens one end at each outlet channel. This allows the outlet channels on the cell stack to be alternately opened and closed in normal operation and in shutdown mode.

In an advantageous further development of the method proposed according to the invention, a first outlet channel for the gaseous medium, in particular H₂, comprises an open end at one end, wherein the second outlet channel on the opposite side comprises an open end relative to the electrochemical cells at its end opposite the open end of the first outlet channel.

In an advantageous further development of the method proposed according to the invention, the gaseous medium, in particular H₂, flows out of same at both open ends of the outlet pipe in opposite directions according to a).

In a method variant of the method proposed according to the present invention, a greatest difference in terms of flow path lengths between all electrochemical cells within the cell stack is at least halved. The significant shortening of the flow path lengths leads to a significant equalization of the pressure distribution within the cell stack with respect to the gaseous medium, in particular H₂.

In a further advantageous further development of the method proposed according to the invention, according to b), the gaseous medium, in particular H₂, leaves the cell stack in opposite directions via two parallel outlet channels at their open ends.

In the method proposed according to the present invention, a sum of flow path lengths for the gaseous medium, in particular H₂, between a corresponding electrochemical cell and open ends of the first and second outlet channels is substantially the same for all electrochemical cells within the cell stack.

In the further development of the method proposed according to the invention, in a first operating mode of the cell stack, in which gaseous medium, in particular H₂, is generated, a first diagonally arranged pair of valves is transferred to its open position and the gaseous medium, in particular H₂, escapes from the cell stack, while a second diagonally arranged pair of valves assumes its closed position in the first operating mode. In the first mode of operation, a continuous production of gaseous medium, in particular H₂, is thus ensured.

In the method proposed according to the invention, in the shutdown mode of the cell stack in which production of the gaseous medium, in particular H₂, is shut down, the first diagonally arranged pair of valves is transferred to the closed position, while the second diagonally arranged pair of valves assumes its open position. In the shutdown mode, the gaseous medium still present in the cell stack thus leaves the latter.

In the further development of the method proposed according to the invention, gaseous medium, in particular H₂, is driven out from the cell stack by flushing it with an inert gas via the second diagonally arranged pair of valves in the open position. Flushing the cell stack with inert gas, for example air or nitrogen, transfers the cell stack to a safe state in the shutdown mode by removing all residues of gaseous medium, in particular H₂, from the cell stack.

Moreover, the invention relates to the use of the method according to the invention set forth above for operating an electrolyzer or a fuel cell for driving an electrically driven vehicle.

The method proposed according to the invention for operating a cell stack comprising a plurality of electrochemical cells arranged one above the other can significantly improve its operation. On the one hand, the method proposed according to the present invention can achieve an equalization of the pressure level in the electrochemical cells forming the cell stack. Equalizing the pressure level within the cell stack results in a more even flow characteristic and thus an improved utilization of all components within the cell stack. Furthermore, the operating method proposed for the cell stack according to the invention can advantageously increase the total yield of gaseous medium, in particular H₂, so that the cell stack as a whole can be operated substantially more effectively.

Equalizing the pressure level within the cell stack can also counteract the phenomenon that occurs between adjacent electrochemical cells within the cell stack and is provided by the fact that the flow paths of the gaseous medium differ from electrochemical cell to electrochemical cell. The solution proposed according to the invention for equalizing the pressure level can reduce flow resistances for the flow of the gaseous medium, which can occur if the electrochemical cells are located further inwards and further away from the outlet channels.

### BRIEF DESCRIPTION OF THE DRAWINGS

Embodiments of the invention are described in greater detail hereinafter with reference to the drawings and the subsequent description.

### Shown are:

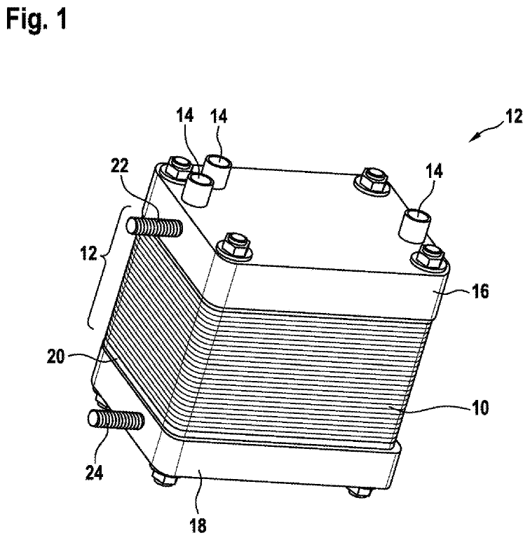

FIG. 1 a perspective view of a cell stack comprising a plurality of electrochemical cells arranged one above the other, including upper and lower end plates,

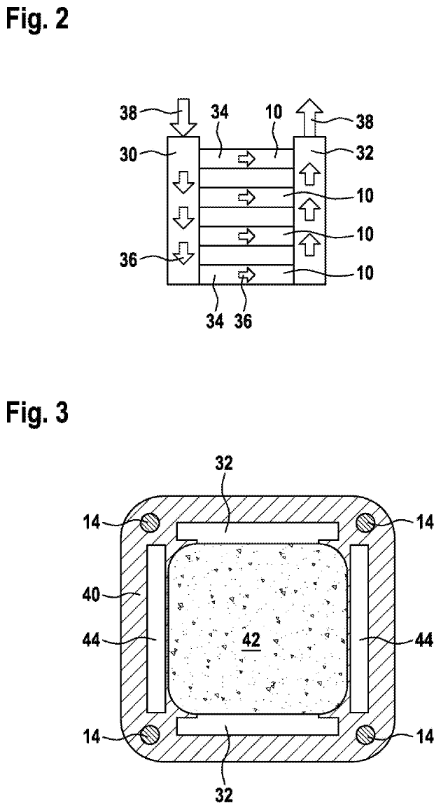

FIG. 2 different scenarios of a flow through of a cell stack shown schematically here with a plurality of electrochemical cells arranged one above the other with a circulating reactant,

FIG. 3 a top plan view of a seal arranged between two electrochemical cells arranged one above the other comprising channels for different media,

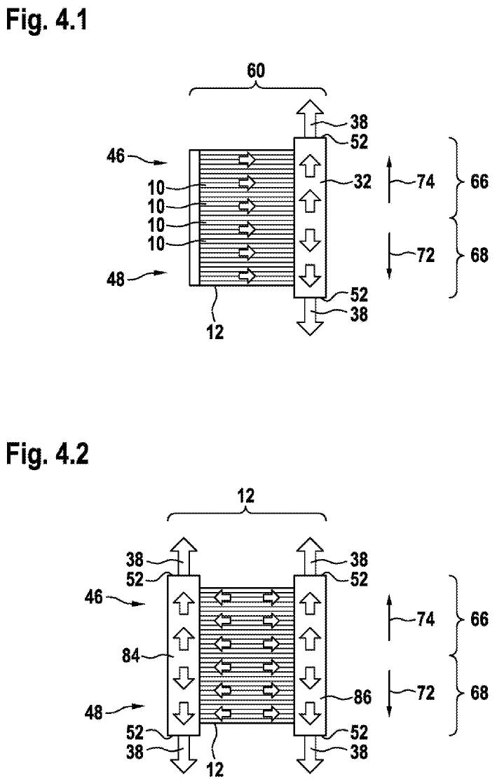

FIGS. 4.1 and 4.2 schematically shows the flow through of one half of a cell stack and the flow through of a complete cell stack,

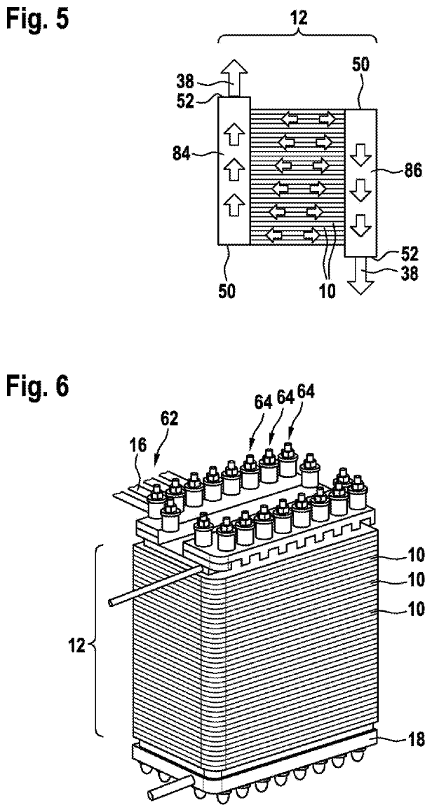

FIG. 5 a preferred flow variant in the cell stack,

FIG. 6 the view of a cell stack consisting of electrochemical cells with straight and curved connectors,

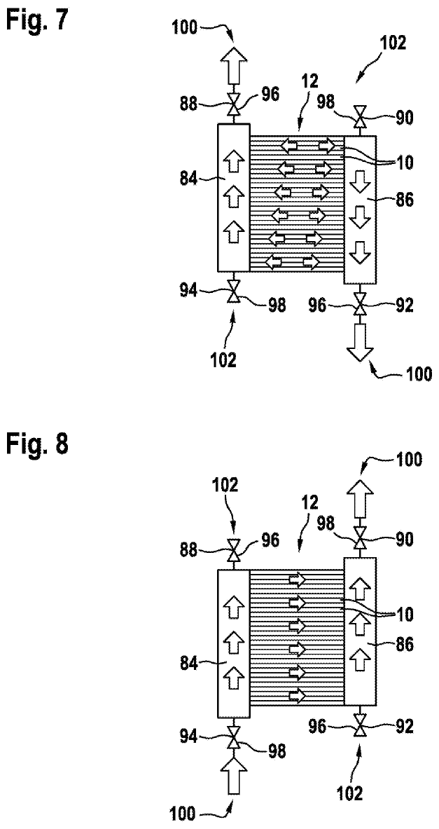

FIG. 7 a first operating mode of the cell stack for the production of gaseous medium, in particular H₂, and

FIG. 8 a shutdown mode of the cell stack in which it is flushed with an inert gas.

### DETAILED DESCRIPTION

In the following description of the embodiments of the invention, identical or similar elements are denoted by identical reference signs, whereby a repeated description of these elements is omitted in individual cases. The drawings show the subject matter of the invention only schematically.

FIG. 1 shows in a perspective view a cell stack 12 comprising a number of stacked electrochemical cells 10 arranged stacked one above the other. The cell stack 12 is fixed by connectors 14 extending substantially in the vertical direction. At the top of the cell stack 12 is a top end plate 16 with connectors arranged thereon; the cell stack 12 has a lower end plate 18 on its underside. An insulation plate 20 is assigned to the end plates 16, 18 on their side facing the cell stack 12. A first current collector 22 and a second current collector 24 are shown on the side of the cell stack 12. The individual electrochemical cells 10 comprise bipolar plates, i.e., active areas as known in the prior art, for example 24 individual electrochemical cells 10 may be located within a cell stack 12. Their number may vary depending on the height of the cell stack 12.

FIG. 2 shows how a gaseous medium 38, in particular H₂, flows through a cell stack 12 shown only schematically in this figure. According to FIG. 2, at least one inlet channel 30 extends substantially in the vertical direction and at least one outlet channel 32 is parallel thereto. Individual transverse connectors 34 and electrochemical cells 10 are arranged between these. The gaseous medium 38 entering the inlet channel 30 at its upper end flows through the electrochemical cells 10 arranged one above the other in the cell stack 12. The gaseous medium 38, in particular H₂, leaves the electrochemical cells 10 arranged one above the other via the at least one outlet channel 32 at its upper end.

FIG. 3 shows a plan view of a seal 40. The seal 40 is preferably provided within the cell stack 12 between the individual electrochemical cells 10 arranged one above the other in the vertical direction, in order to seal them off from one another when the connectors 14 are tensioned within the cell stack 12. It can be seen from the top plan view according to FIG. 4 that outlet channels 32 for the gaseous medium 38, in particular H₂, run through the seal 40, opposite one another. Furthermore, the seal 40 has a porous layer 42 (PTL) in its middle region. Furthermore, channels 44 are provided in the seal for gaseous hydrogen (H₂). If the individual electrochemical cells 10 are arranged one above the other with the seal 40 shown in the top plan view in FIG. 3, channels extending in the vertical direction through the cell stack 12 are created in the drawing plane, as indicated by positions 32 and 44 in FIG. 3.

In the schematic representation according to FIG. 4.1, one half 60 of the cell stack 12 is shown, whereas a complete cell stack 12 is shown in the schematic representation according to FIG. 4.2.

The illustration according to FIG. 4.1 shows that the gaseous medium 38, in particular H₂, generated in the cell stack 12 or in the half 60 of the cell stack 12 flows from the individual electrochemical cells 10 between a top side 46 and a bottom side 48 of the cell stack 12 and the outlet channel 32. The outlet channel 32 is provided with open ends 52. As a result, the gaseous medium 38, in particular H₂, may flow in a first partial flow 66 and a second partial flow 68 via outlet channel 32 and its open ends 52. With respect to the outlet channel 32 shown in FIG. 4.1, it must be noted that the mentioned partial flows 66, 68 leave the outlet channel 32 in the flow directions 72, 74 opposite to one another, namely in the first flow direction 72 downward and in the second flow direction 74 upward towards the top 46. In FIG. 4.1, the end plates 16, 18 limiting the cell stack 12 are not shown, compare with the schematic representation according to FIG. 6.

From the representation according to FIG. 4.2, the flow ratios with a completely illustrated cell stack 12 are shown in more detail. In this case, a first outlet channel 84 and a second outlet channel 86 are located opposite each other laterally to the cell stack 12. The first outlet channel 84 and the second outlet channel 86 also have open ends 52, via which the gaseous medium 38, in particular H₂, leaves the cell stack 12 again at the top 46 and at the bottom 48. Here too, the partial flows 66, 68 are created in the outlet channels 84, 86, which leave the two outlet channels 84, 86 arranged opposite each other in opposite flow directions 72, 74 (see illustration in FIG. 4.1). In contrast to the flow characteristics described above with reference to FIGS. 4.1 and 4.2, the flow ratios are represented differently according to the schematic representation in FIG. 5.

From FIG. 5 it can be seen that the cell stack 12 also comprises two outlet channels, namely the first outlet channel 84 and the second outlet channel 86, which run parallel to one another. The two outlet channels 84, 86 running parallel to each other remove the generated gaseous medium 38, in particular H₂, from the cell stack 12. The two outlet channels 84, 86 running parallel to each other are provided with closed ends 50 at opposite ends and also each have diagonally opposite open ends 52, via which the gaseous medium 38, in particular H₂, flows out of the cell stack 12. According to the schematic illustration in FIG. 5, the first outlet channel 84 is provided with an open end 52 at its top end and has a closed end 50 at its bottom end. In the opposite second outlet channel 86, the closed end 50 and the open end 52 are interchanged relative to the first outlet channel 84. This means that according to the flow guide in FIG. 5, the gaseous medium 38 leaves the first outlet channel 84 at its open end 52 at the top 46 and the gaseous medium 38, in particular H₂, exits at the bottom end of the second outlet channel 86 in the area of its bottom 48. In the flow variant shown in FIGS. 4.1 and 4.2, the gaseous medium 38, in particular H₂, leaves the outlet channels 32; 84, 86 via open ends 52 at the upper and lower sides 46, 48 in opposite flow directions 72, 74. As a result, the greatest difference between the corresponding flow path lengths in relation to all electrochemical cells 10 of the cell stack 12 is essentially halved.

In the flow arrangement according to FIG. 5, the gaseous medium 38, in particular H₂, leaves the cell stack 12 via two outlet channels 84, 86, which, however, have a closed end 50 at one end and only have an open end 52 at the end opposite to this, via which the gaseous medium 38, in particular H₂ can escape from the cell stack 12. As a result, according to the flow variant in FIG. 5, the sum of the flow path lengths for the gaseous medium 38, in particular H₂, between a corresponding electrochemical cell 10 and the open ends 52 of the two outlet channels 84, 86 is substantially the same for all electrochemical cells 10, each of which is arranged one above the other in the cell stack 12.

FIG. 6 shows a perspective view of an assembled cell stack 12. The individual electrochemical cells 10 arranged one above the other are separated from each other via seals 40. In the cell stack 12 shown in FIG. 6, for example, 24 electrochemical cells 10 are arranged one above the other. These are limited by an upper end plate 16 and a lower end plate 18. Connections 64 are located on top end plate 16. The connections 64 for the media flowing through the cell stack 12 or the gaseous medium 38 exiting from it, in particular H₂, may either be oriented upward in the vertical direction or also have a 90° orientation 62, as schematically indicated in FIG. 6. If the connections 64 are provided in an angled position, i.e., with a 90° orientation 62, the overall height of a fully assembled cell stack 12 as shown in FIG. 6 can be advantageously reduced.

FIGS. 7 and 8 show two different operating modes of the cell stack 12.

FIG. 7 shows a first operating mode of the cell stack 12. From FIG. 7 it can be seen that the cell stack 12 comprises the two outlet channels 84, 86 running parallel to one another. At their opposite ends there is a first valve 88, a second valve 90, a third valve 92, and a fourth valve 94. Said valves 88, 90, 92, 94 may be switched between an open position 100 and a closed position 102.

A first diagonally arranged pair of valves 96 is formed by the first valve 88 and the third valve 92; a second, diagonally arranged pair of valves 98 is formed by the second valve 90 and the fourth valve 94.

In the first operating mode shown in FIG. 7 and depicting the normal operating mode of the cell stack 12, the first diagonally arranged pair of valves 96 is opened, while the second diagonally arranged pair of valves 98 assumes its closed position 102. As a result, gaseous medium 38, in particular H₂, flows out of the cell stack 12 during normal operation of the cell stack 12. The operating mode shown in FIG. 7 substantially corresponds to the flow ratios of the gaseous medium 38 as shown in FIG. 5.

If the cell stack 12 is now switched off, i.e. if it is operated in shutdown mode, the first diagonally arranged pair of valves 96 with the first valve 88 and the third valve 92 is moved to its closed position 102, as shown in FIG. 8, while the second diagonally arranged pair of valves 98 with its valves 90 and 94 is moved to its open position 100. The gaseous medium 38 remaining in the cell stack 12 is now driven out in such a manner, that, for example, an inert gas, such as air or nitrogen, is introduced into the cell stack 12 at the fourth valve 94 located in its open position 100, which flushes it and expels gaseous medium 38, in particular H₂, remaining in the outlet channels 84, 86 or the electrochemical cells 10 arranged one above the other in between through the second valve 90 located in its open position 100. Thus, in the shutdown mode according to the schematic representation in FIG. 8, gaseous medium 38, in particular H₂, remaining in the cell stack 12 can be completely removed from it so that the cell stack 12 transitions safely to a resting state, i.e. to a switched off state.

After flushing the cell stack 12 according to FIG. 8, all four valves 88, 90, 92, 94 can be transferred to their closed position 102 as long as the cell stack 12 is not operating so as to prevent the intrusion of contamination into the cell stack 12.

Flushing the cell stack, i.e. the expulsion of remaining gaseous medium 38, in particular H₂, is favorable in that otherwise the membrane on the anode side would be contaminated even in small quantities, which makes it difficult to smoothly restart the cell stack 12 at a later time. Furthermore, gaseous medium 38, in particular H₂, remaining in the cell stack 12 may chemically react and attack the membrane of the electrochemical cells 10 within the cell stack 12. This is prevented by the complete expulsion of the gaseous medium 38, in particular H₂.

The invention is not limited to the exemplary embodiments described herein and the aspects highlighted thereby. Rather, within the range specified by the claims, a plurality of modifications is possible, which lie within the abilities of a skilled person.

1. A method for operating a cell stack (12) comprising a number of electrochemical cells (10) which are arranged one above the other, are sealed off from one another, and through which a gaseous medium (38) flows, which gaseous medium leaves the cell stack (12) via at least one outlet channel (32; 84, 86), wherein
a) one outlet channel (32) for the gaseous medium (38) comprises open ends (52) at its ends for an outflow of the gaseous medium (38), or
b) a first outlet channel (84) for the gaseous medium (38) and a second outlet channel (86) for the gaseous medium (38) are alternately opened or closed at their ends by diagonally acting pairs (96, 98) of valves (88, 90, 92, 94) in such a way that, at the first and at the second outlet channel (84, 86), one end is always a closed end (50), and an opposite end is always an open end (52).

2. The method according to claim 1, wherein controllable valves (88, 90, 92, 94) are assigned to each end of the outlet channels (84, 86) that close one end at each outlet channel (84, 86) and open an opposite end.

3. The method according to claim 1, wherein the first outlet channel (84) for gaseous medium (38) comprises an open end (52) at one end and the second outlet channel (86) comprises an open end (52) at an opposite side relative to the electrochemical cells (10) at its end opposite to the open end (52) of the first outlet channel (84).

4. The method according to claim 1, wherein, according to a), the gaseous medium (38) flows out at both open ends (52) of the outlet channel (82) in flow directions (72, 74) which are opposite to each other.

5. The method according to claim 4, wherein, according to a), a greatest difference in terms of flow path lengths between all electrochemical cells (10) in the cell stack (12) is at least halved.

6. The method according to claim 1, wherein, according to b), gaseous medium (38) leaves the cell stack (12) again via two parallel outlet channels (84, 86) at their open ends (52) in opposite flow directions (72, 74) in each outlet channel (84, 86).

7. The method according to claim 6, wherein a sum of flow path lengths for the gaseous medium (38) between a corresponding electrochemical cell (10) and open end (52) of the first and second outlet channels (84, 86) is substantially the same for all electrochemical cells (10) within the cell stack (12).

8. The method according to claim 1, wherein in a first operating mode of the cell stack (12), in which gaseous medium (38) is generated, a first diagonally arranged pair of valves (96) assumes an open position (100), and the gaseous medium (38) escapes from the cell stack (12), while a second diagonally arranged pair of valves (98) assumes a closed position (102).

9. The method according to claim 1, wherein in a shutdown mode of the cell stack (12), in which production of the gaseous medium (38) is reduced, a first diagonally arranged pair of valves (96) assumes a closed position (102) and a second diagonally arranged pair of valves (98) assumes an open position (100).

10. The method according to claim 9, wherein gaseous medium (38) is expelled via the second diagonally arranged pair of valves (98) in the open position (100) by flushing the cell stack (12) with an inert gas.

11. The method according to claim 9, wherein the cell stack (12) is flushed with air or nitrogen.

12. A use of the method according to claim 1 for operating an electrolyzer or a fuel cell for driving an electrically driven vehicle.

13. The method according to claim 1, wherein the gaseous medium (38) is H₂.
